(19) United States
(12) Patent Application Publication
(10) Pub. No.: US 2007/0046184 A1
(43) Pub. Date: Mar. 1, 2007

(54) Organic electroluminescent device

(76) Inventors: Yen-Chin Chiang, Hsinchu (TW); Hsueh Chin Peng, Hsinchu (TW); Li-Sha Yu, Hsinchu (TW); Chien Le Li, Hsinchu (TW); Li-Min Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/503,072

(22) Filed: Aug. 14, 2006

(30) Foreign Application Priority Data
Aug. 25, 2005 (TW) 094129080

(51) Int. Cl. H01J 1/62; H01J 63/04

(52) U.S. Cl. 313/504

(57) ABSTRACT

An organic electroluminescent device comprises a lower electrode provided on the surface of a color filter, wherein the lower electrode is directly provided on the surface of an overcoat layer. An isolation layer is further provided between the lower electrode and the overcoat layer, such that the connection between the lower electrode and the color filter can be proceeded beneficially. Besides, the situation of barrier layer broken will be not happened. Thus, the structure completeness of the organic electroluminescent device can be held, and the production yield of that can be improved.

### FIELD OF THE INVENTION

The present invention relates to an organic electroluminescent device, and more particularly to an organic electroluminescent device used for maintaining the structure thereof, and improving the production yield.

### BACKGROUND OF THE INVENTION

According to vigorous development of optoelectronics industry, people enjoy the convenient of such technology. However, how to obtain a flat display with high definition and low cost, is the object for the each manufacture. With in various displays, organic electroluminescent device has the benefits with self illumination, high brightness, wide viewing angle, low power consumption, high response speed, thin film panel, and simple element structure, according to comparison with other display skill. Therefore, such has more eyes from research organizations and manufactures.

According to various displays, how to obtain full-color display, is the key point for success. As the organic electroluminescent device, there are three general methods for obtaining full-color display as following descriptions.

1. Three color lighting layer structure: such comprises self illumination organic light emitting elements for three primary colors as Red (R), Green (G), and Blue (B) to obtain full-color display.

2. Color change media (CCM): such has a light source from a blue organic light emitting element, and luminesces a light color conversion film according to the blue light for obtaining the three primary colors (RGB) to achieve full-color display.

3. Color filter (CF): such has a white color organic light emitting element as a backlight source, and coordinates with a color filter, thus, when the color filter is illuminated from the backlight source, the full-color display can be achieved.

Referring to FIG. 1, is a cross-sectional view of prior art organic electroluminescent device. The organic electroluminescent device (OLED) 200 comprises at least one organic light emitting element 20 provided on the partial surface of a color filter 10. The color filter 10 comprises at least one black matrix 13 and at least one color resist 15 provided on the partial surface of a transmittance substrate 11. Further, an overcoat 17 is covered on the surface of the black matrix 13 and the color resist 15, and a barrier layer 19 is provided on the surface of the overcoat layer 17. The barrier layer 19 advantages the lower electrode 21 of the organic light emitting element 20 provided on the surface of the color filter 10.

However, the barrier layer 19 can be made selectively by a Silicon Oxide, a Silicon Nitride, or a Silicon-Oxy-Nitride. Therefore, the barrier layer 19 is easily to be broken, and when the organic electroluminescent 200 is displaying, the dark spots will be occurred, thus, the yield of production will also be affected.

### SUMMARY OF THE INVENTION

Accordingly, how to design a novel organic electroluminescent device with respect to the previous mentioned shortcomings of the prior art, preventing the barrier layer broken and advantaging the lower electrode provided, is the key point of the present invention. Therefore,

It is a primary object of the present invention to provide an organic electroluminescent device, comprising a color filter without a barrier layer provided, thus, the barrier layer will not be broken within the color filter.

It is a secondary object of the present invention to provide an organic electroluminescent device, comprising an isolation layer provided on the surface of a color filter, thus, the lower electrode will be advantageously provided on the partial surface of the color filter.

To achieve the previous mentioned objects, the present invention provides an organic electroluminescent device, comprising a color filter, comprising at least one color resist provided on the surface of a transmittance substrate; an overcoat layer provided on the partial surface; at least one isolation layer provide on the partial surface of the overcoat layer, and a lower electrode provided on the surface of the isolation layer; an organic light emitting layer provided on the partial surface of the lower electrode; and at least one opposite electrode provided on the surface of the organic light emitting layer.

To achieve the previous mentioned objects, the present invention further provides an organic electroluminescent device, comprising a color filter, comprising at least one color resist provided on the surface of a transmittance substrate; an overcoat layer provided on the partial surface; at least one isolation layer made by a metal material with light transmittance and electrical conductibility, and provide on the partial surface of the overcoat layer, and a lower electrode provided on the surface of the isolation layer; an organic light emitting layer provided on the partial surface of the lower electrode; at least one opposite electrode provided on the surface of the organic light emitting layer; and a sealing plate provided on the surface of the overcoat layer of the color filter.

### BRIEF DESCRIPTION OF THE DRAWINGS

It will be understood that the figures are not to scale since the individual layers are too thin and the thickness differences of various layers too great to permit depiction to scale.

FIG. 1 is a cross sectional view of a prior art organic electroluminescent device;

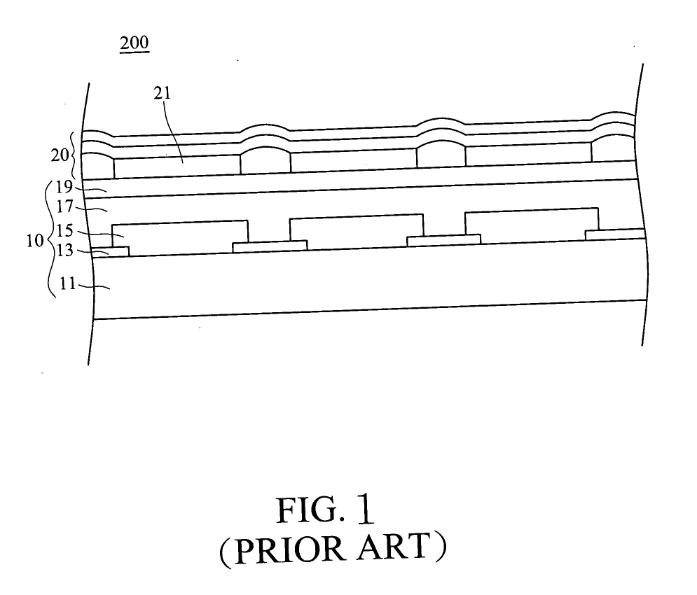

FIG. 2 is a cross sectional view of a preferred embodiment of the present invention organic electroluminescent device; and

FIG. 3 is a cross sectional view of another preferred embodiment of the present invention organic electroluminescent device.

### DETAILED DESCRIPTION OF THE INVENTION

The structural features and the effects to be achieved may further be understood and appreciated by reference to the presently preferred embodiments together with the detailed description.

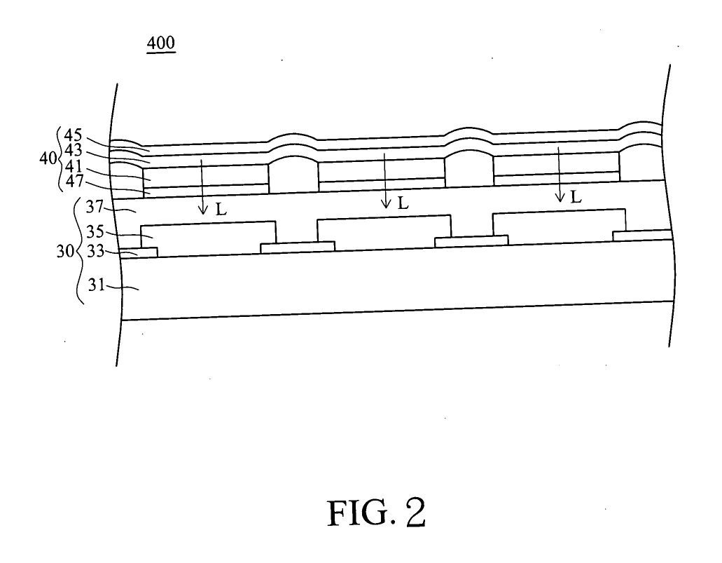

Referring to FIG. 2, is a cross sectional view of a preferred embodiment of the present invention organic electroluminescent device. The organic electroluminescent device 400 comprises a color filter 30 with at least one organic light emitting element 40 provided on the partial surface thereof. The color filter 30 comprises at least one black matrix 33 provided on the partial surface of a transmittance substrate 31, a color resist 35 with color filtering function, provided on the partial surface of the black matrix 33 and the transmittance substrate without the black matrix 33, and an overcoat layer 37 covered on the black matrix 33 and the color resist 35.

At least one isolation layer 47 is provided on the partial surface of the overcoat layer 37 of the color filter 30. And, the surface of the isolation layer 47 comprises a lower electrode 41 within the organic light emitting element 40. An organic light emitting layer 43 is provided on the partial surface of the lower electrode 41. After providing the organic light emitting layer 43, an opposite electrode 45 is provided on the surface of the organic light emitting layer 43.

Wherein, the surface of the overcoat layer 37 of the color filter 30 is without a barrier layer provided 19, such that can prevent the barrier layer 19 broken as the prior art structure. Thus, the organic electroluminescent device 400 won't occur the dark spots according to the barrier layer 19 broken, and further improve the yield of production.

The lower electrode 41 connects to the overcoat layer 37 through the isolation layer 47. And, the isolation layer 47 is made by a metal material with light transmittance and electrical conductibility, such as chromium, nickel, molybdenum, and a combination thereof. Of course, due to another embodiment of the present invention, the isolation layer 47 can be also as a chemical compound, which comprises the chromium, nickel, and molybdenum. And, within application, the transmittance of the isolation layer 47 is larger than 70% for advantaging the color light source illumination efficiency from the organic light emitting element 40, and maintaining the display brightness of that. The lower electrode 41 is made by a material with light transmittance and electrical conductibility, such as ITO, IZO, IWO, and AZO.

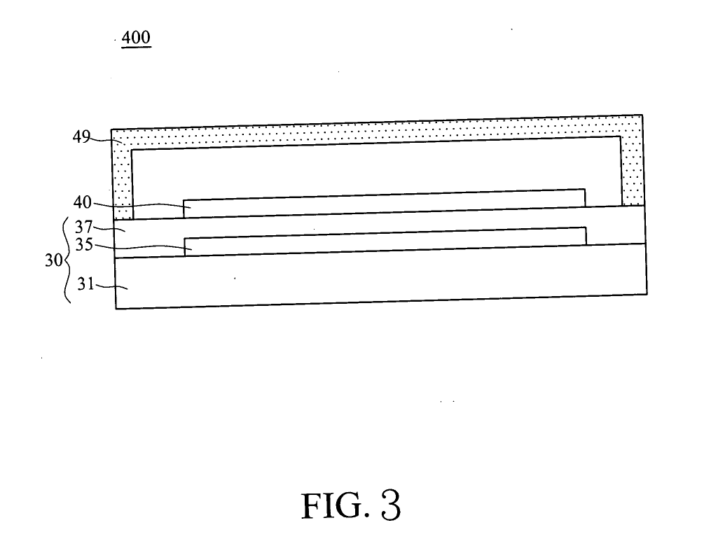

Finally, referring to FIG. 3, is a cross sectional view of another preferred embodiment of the present invention organic electroluminescent device. An organic light emitting element 40 is provided on the partial surface of a color filter 30, and a sealing plate 49 is provided on the partial surface of a black matrix 33 and the partial surface of the color filter 30 without the organic light emitting element 401 provided. Wherein, the color filter 30 comprises at least one color resist 35 provided on the partial surface of a transmittance substrate 31. And, an overcoat layer 37 is provided on the color resist 35 and the partial surface of the transmittance substrate 31 without the color resist provided, thus, after forming the color filter 30, an isolation layer 47 is further provided on the partial surface of overcoat layer 37 of the color filter 30. The surface of the isolation layer 47 provides a lower electrode 41, an organic light emitting layer 43, and an opposite electrode 45 in order, such that is consisted of the organic light emitting element 40. After providing the organic light emitting element 40, a sealing plate is provided on the partial surface of the color filter 30, and the organic light emitting element 40 is within the sealing plate 49, thus, the purpose of protecting the organic light emitting element 40 is achieved. Wherein, the sealing plate 49 is provided on the partial surface of the overcoat layer 37 of the color filter 30.

In summary, it is appreciated that the present invention is related to an organic electroluminescent device, and more particularly to an organic electroluminescent device used for maintaining the structure thereof, and improving the production yield.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

10 color filter
11 transmittance substrate
13 black matrix
15 color resist
17 overcoat layer
19 barrier layer
20 organic light emitting element
200 organic electroluminescent device
21 lower electrode
30 color filter
31 transmittance substrate
33 black matrix
35 color resist
37 overcoat layer
40 organic light emitting element
400 organic electroluminescent device
41 lower electrode
43 organic light emitting layer
45 opposite electrode
47 isolation layer
49 sealing plate

I claim:

1. An organic electroluminescent device, comprising:
a color filter, comprising at least one color resist provided on the surface of a transmittance substrate; an overcoat layer provided on said color resist and the partial surface of said transmittance substrate without said color resist;
at least one isolation layer provide on the partial surface of said overcoat layer, and a lower electrode provided on the surface of said isolation layer;
an organic light emitting layer provided on the partial surface of said lower electrode; and
at least one opposite electrode provided on the surface of said organic light emitting layer.

2. The organic electroluminescent device of claim 1, wherein said isolation layer is made by a metal material with light transmittance and electrical conductibility.

3. The organic electroluminescent device of claim 1, wherein the transmittance of said isolation layer is larger than 70%.

4. The organic electroluminescent device of claim 1, wherein said isolation layer can be made selectively from one of chromium, nickel, molybdenum, and a combination thereof.

5. The organic electroluminescent device of claim 1, wherein said isolation layer can be as a chemical compound made selectively from one of chromium, nickel, and molybdenum.

6. The organic electroluminescent device of claim 1, wherein further comprises a sealing plate provided on the partial surface of said overcoat layer of said color filter.

7. The organic electroluminescent device of claim 1, wherein said lower electrode is made by a material with light transmittance and electrical conductibility.

8. The organic electroluminescent device of claim 7, wherein said material with light transmittance and electrical conductibility can be selectively as one of ITO, IZO, IWO, and AZO.

9. The organic electroluminescent device of claim 1, wherein further comprises at least one black matrix provided on the partial area between said color resist and said transmittance substrate.
